(19) United States
(12) Patent Application Publication
(10) Pub. No.: US 2020/0316846 A1
(43) Pub. Date: Oct. 8, 2020

(54) Embossing Apparatus

(71) Applicant: SEIREN CO., LTD., Fukui (JP)

(72) Inventor: Shigeru Nakajima, Fukui (JP)

(73) Assignee: SEIREN CO., LTD., Fukui (JP)

(21) Appl. No.: 16/650,511

(22) PCT Filed: Sep. 22, 2018
(86) PCT No.: PCT/JP2018/035233

§ 371 Date: Mar. 25, 2020

(30) Foreign Application Priority Data
Sep. 29, 2017 (JP) 2017-191509

(51) Int. Cl. B29C 59/02

(52) U.S. Cl. CPC B29C 59/022; D06N 3/0077

(57) ABSTRACT

In an embossing apparatus, an embossing die includes a concavo-convex shaped molding unit. The molding unit is in contact with a front face of a base material. An embossing receiving die includes an elastic unit made of resin. The elastic unit is in contact with a back face of the base material. In the molding unit, a height difference (ΔH) between a top portion of a convex portion and a bottom portion of a concave portion is a first value. In the elastic unit, a surface which forms an outer surface of the embossing receiving die is a smooth surface. In the elastic unit, a thickness (T) in a direction perpendicular to the outer surface of the embossing receiving die is a second value equal to or greater than the first value. The embossing die and the embossing receiving die sandwich the base material between the molding unit and the elastic unit.

### TECHNICAL FIELD

The present invention relates to an embossing apparatus.

### BACKGROUND ART

Technologies related to embossing has been proposed. For example, in patent literature 1, a method to manufacture a seat skin material is disclosed. The seat skin material is formed by providing an embossed pattern on a front face of an elongated material. The manufacturing method includes a step of pressing the elongated material. In this step, the elongated material passes between an embossing roll and a flat roll. The embossing roll is provided with a plurality of embossing portions protruding from a base surface. When the elongated material passes between the embossing roll and the flat roll, a front face fabric, a back face fabric and a cushion material are heat-sealed to each other by heating and pressing with the embossing portions. Furthermore, since both the embossing roll and the flat roll are heated, the front face fabric and the back face fabric are heat-sealed with the cushion material. The cushion material is in a state in which the portion to be heat-sealed is compressed. On the front face fabric side of the seat skin material, concave portions are formed by heating and pressing with the embossing portions. On the back face fabric side of the seat skin material, concave portions are formed at positions corresponding to the concave portions of the front face fabric. By the embossing, a seat skin material having an embossed pattern in which a plurality of concave portions are formed on each surface of the front face fabric and the back face fabric is formed.

In patent literature 2, a method to manufacture a seat skin material is disclosed. The seat skin material is obtained by embossing an elongated material. The elongated material is a laminated sheet formed by sandwiching a cushion material between a front face fabric and a back face fabric. A base surface of an embossing roll includes an embossing portion. A surface of a heat roll is a smooth surface. The elongated material passes between the embossing roll and the heat roll in a state in which a predetermined tension is applied to the elongated material. At that time, the embossing portion is pressed against a front face of the elongated material. The embossing roll is arranged at the following position with respect to the heat roll. The previously described position is a position where the embossing portion bites into the front face of the elongated material by a predetermined depth and where the base surface does not contact the front face of the elongated material. The embossing roll is provided with a first heating mechanism. The heat roll is provided with a second heating mechanism. In the embossing roll, a heating temperature is controlled by the first heating mechanism. In the heat roll, the heating temperature is controlled by the second heating mechanism separately from the first heating mechanism. In the portion of the elongated material to which the embossing portion is pressed, the elongated material is in a state in which the entire thickness direction is heated. In the cushion material, a synthetic resin is thermal softened and the volume is compressed. Along with this, a concave shape is formed on a side of the back face fabric of the elongated material portion against which the embossing portion is pressed. In the portion of the elongated material where the embossed portion is not pressed, thermal softening of the cushion material does not occur. Therefore, the previously described portion of the back face fabric side is held as a convex shape.

In patent literature 3, a method for embossing a leather-like sheet is disclosed. In the embossing method, the leather-like sheet is hot embossed between a metal roll or a metal endless belt and a back roll. The leather-like sheet is composed of a fibrous substrate and a thermoplastic elastic resin. The back roll has a two-layer structure in which an outer layer of a rubber roll is covered with a sponge layer. In the rubber roll, a hardness measured with a rubber JIS hardness meter is 20 degrees or more and less than 100 degrees. In the sponge layer, the hardness measured with an Asker C-type hardness meter is 5 degrees or more and less than 100 degrees.

In patent literature 4, an embossing apparatus is disclosed. The embossing apparatus includes an embossing roll and a pinching roll. In the embossing roll, a patterning board is mounted on a peripheral surface of a roll body. The patterning board is made of a photosensitive synthetic resin whose surface is a concavo-convex surface. The pinching roll is composed of an elastic material layer to an outer peripheral surface thereof. The elastic material layer has a lower hardness than patterning board. The elastic material layer is formed of urethane rubber having a required thickness. A hardness of the elastic material layer has a rubber JIS hardness of about 40 to 80°. According to the embossing apparatus, a deep and sharp embossed pattern can be applied to a workpiece at a relatively low pressure nip.

### PRIOR ART DOCUMENTS

### Patent Literature

Patent Literature 1: Japanese Patent No. 5913755
Patent Literature 2: Japanese Published Unexamined Application No. 2016-147432
Patent Literature 3: Japanese Published Examined Application No. H03-2648
Patent Literature 4: Japanese Published Examined Utility Model No. S53-17347

### SUMMARY OF INVENTION

### Problems to be Solved by the Invention

A decorative sheet has been put to practical use. The decorative sheet is a decoration sheet having a concavo-convex pattern on a front face of a base material. The base material includes, for example, various sheet materials from which one or both of thickness and a material differ. The base material may be a laminated body. When the base material is a laminated body, this base material is formed by bonding at least a first sheet and a second sheet. In this case, the first sheet forms, for example, a front face of the base material that is a front side of the base material. The front face of the base material becomes a front face of the decorative sheet after embossing. The inventor is aware that when the front face of the base material is embossed at the manufacturing site, a sufficient concavo-convex pattern may not be shaped on the front face of the base material. The inventor considers that the previously described problem likely occurs when the base material is thick and has cushioning properties.

The decorative sheet is, for example, may be sewn in the following first state, second state or third state. The first state is, for example, a state in which front faces of two decorative sheets are in contact with each other. The second state is a state in which the front face of the decorative sheet is in contact with a front face or a back face of a predetermined fabric that is not the decorative sheet. The third state is a state in which back faces of two decorative sheets are in contact with each other. An example of a case where sewing is performed in the third state is a case where a binding is provided on the decorative sheet. For example, a sewing machine is used for sewing. The inventor considered that the following first event could be suppressed during sewing by making the back face of the decorative sheet into a smooth surface. The first event is that the presser of the sewing machine is catching the back face of the decorative sheet. Furthermore, the inventor considered that the following second event could be suppressed by making the back face of the decorative sheet into a smooth surface. The second event is a positional displacement of the two decorative sheets. This positional displacement may occur when providing a binding. Along with this, the inventor considered that it would be possible to improve the work efficiency of sewing.

Then, the inventor studied an embossing technique that can shape a concavo-convex pattern having a desired three-dimensional shape on the front face of the base material even if the base material is a laminated body as described above. In that case, the inventor considered that the back face of the decorative sheet in which the concavo-convex pattern is formed on the front face can be maintained in the same state as the back face of the base material before embossing. The embossing technique which was studied is applicable to various base materials. For example, this embossing technique can be applied to a single-layer base material as well as a base material which is a laminated body of two or more layers.

An object of the present invention is to provide an embossing apparatus which can manufacture the following decorative sheet. The previously described decorative sheet has a three-dimensional concavo-convex pattern on a front face. Furthermore, the previously described decorative sheet has a back face which is maintained in the same state as the state before embossing.

### Solutions to Problems

One aspect of the invention is an embossing apparatus including: an embossing die which includes a concavo-convex shaped molding unit which is in contact with a front face of a base material; and an embossing receiving die including a resin elastic unit which is in contact with a back face of the base material, wherein in the molding unit, a height difference between a top portion of a convex portion and a bottom portion of a concave portion is a first value, and in the elastic unit, a surface which forms an outer surface of the embossing receiving die is a smooth surface, and a thickness in a direction perpendicular to the outer surface of the embossing receiving die is a second value which is equal to or greater than the first value, wherein the embossing die and the embossing receiving die sandwich the base material between the molding unit and the elastic unit.

According to this embossing apparatus, a three-dimensional concavo-convex pattern can be shaped on the front face of the base material. In the decorative sheet, it can suppress the following concave shaped portion to be formed on the back face of the base material. The concave shaped portion previously described is a concave shaped portion corresponding to the concave portion of the concavo-convex pattern on the front face.

The embossing apparatus may include a heating unit which generates heat, wherein the heating unit may be provided in the embossing die and heats the embossing die, and may not be provided in the embossing receiving die. According to this configuration, the elastic unit can be maintained at a desired hardness. The base material can be embossed in a state in which the elastic unit has a hardness suitable for embossing.

### Advantageous Effects of the Invention

According to the present invention, it is possible to obtain an embossing apparatus which can manufacture the following decorative sheet. The previously described decorative sheet has a three-dimensional concavo-convex pattern on a front face. Furthermore, the previously described decorative sheet has a back face which is maintained in the same state as the state before embossing.

### BRIEF DESCRIPTION OF DRAWINGS

FIG. 1 is a side view which shows an example of a schematic structure of an embossing apparatus. An embossing die and an embossing receiving die have roll shapes. With respect to a base material and a decorative sheet, a portion which corresponds to the embossing apparatus is shown.

FIG. 2 is a side sectional view which shows an example of a schematic structure of the base material and the decorative sheet. Each part of the longitudinal direction of an elongated base material and an elongated decorative sheet is shown. The upper row shows the base material before embossing. The lower row shows the decorative sheet after embossing.

FIG. 3 is a side view which shows another example of a schematic structure of an embossing apparatus. An embossing die and an embossing receiving die have a flat plate shape. It shows a state when the embossing die is moved towards a first side of an arrangement direction against the embossing receiving die. With respect to the base material and the decorative sheet, a portion which corresponds to the embossing apparatus is shown.

### DESCRIPTION OF EMBODIMENTS

Embodiments for performing the present invention will be described with reference to the drawings. The present invention is not limited to the configurations described below, and various configurations can be employed in the same technical idea. For example, some of the configurations shown below may be omitted or replaced with other configurations or the like. Other configurations may be included. In each figure of the embodiment, hatching indicates a cut section.

### <Embossing Apparatus, Decorative Sheet, Base Material>

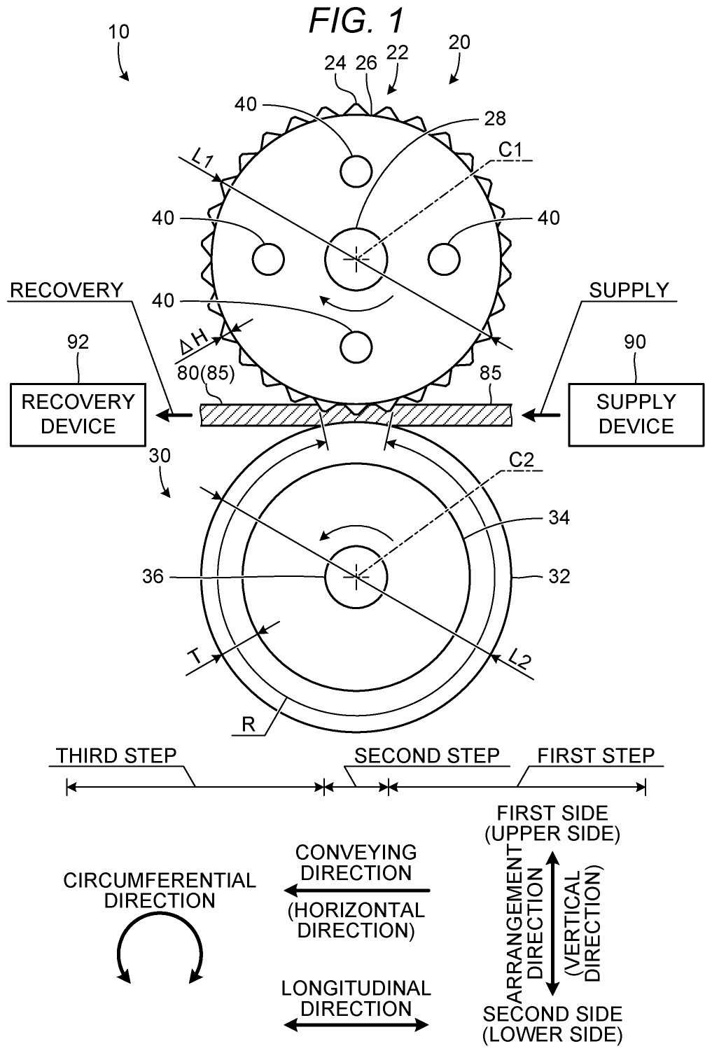

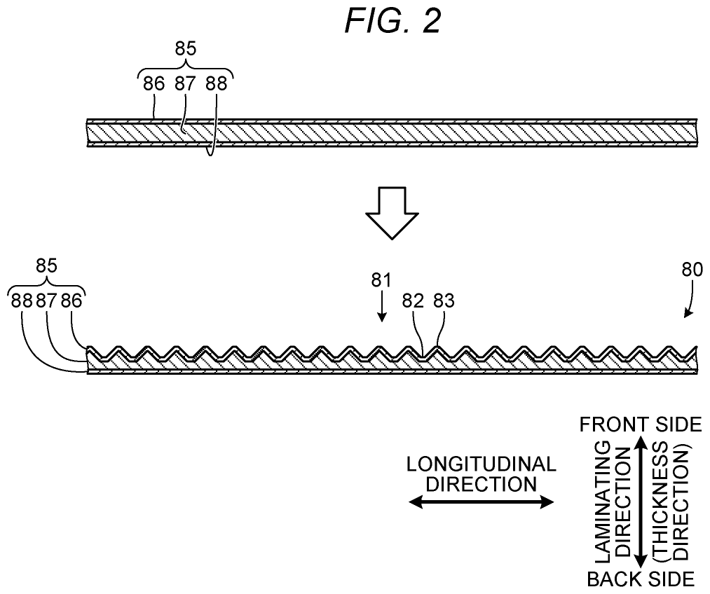

An embossing apparatus 10, a decorative sheet 80 and a base material 85 are described with reference to FIG. 1 and FIG. 2. The embossing apparatus 10 is a processing apparatus that manufactures the decorative sheet 80. The embossing apparatus 10 conveys the elongated base material 85 fed out from a supply device 90 and embosses the base material 85 (see FIG. 1). In the embossing apparatus 10, embossing is continuously performed. The base material 85 is recovered by a recovery device 92 as the decorative sheet 80 after being embossed by the embossing apparatus 10.

In FIG. 1, the illustration of the following parts are simplified. The previously described parts are the base material 85, the decorative sheet 80, the supply device 90 and the recovery device 92. The base material 85 and the decorative sheet 80 have an aspect of an elongated sheet material continuous from the supply device 90 to the recovery device 92. As the supply device 90, a supply device provided in a known embossing apparatus can be employed. As the recovery device 92, a recovery device provided in a known embossing apparatus can be employed. Therefore, the description regarding the supply device 90 and the recovery device 92 is omitted. In the embodiment, the direction in which the base material 85 and the decorative sheet 80 are conveyed from the supply device 90 toward the recovery device 92 is referred to as a “conveying direction”. The conveying direction is a direction along a longitudinal direction of the base material 85 and the decorative sheet 80.

The decorative sheet 80 is a decoration sheet having a concavo-convex pattern 81 on a front face of the base material 85 (see the lower row of FIG. 2). The concavo-convex pattern 81 is formed by a concave portion 82 and a convex portion 83. Examples of the concavo-convex pattern 81 include a pattern in which a plurality of concave portions 82 and a plurality of convex portions 83 are repeated in a transverse direction and the longitudinal direction of the base material 85. Examples of the shape of the concave portion 82 include a cone shape, a frustum shape, a columnar shape and a hemispherical shape. However, in the decorative sheet 80, various concavo-convex patterns are employed as the concavo-convex pattern 81. In the embodiment, the concavo-convex pattern 81 is not limited to a specific concavo-convex pattern. The concavo-convex pattern 81 includes various concavo-convex patterns. Therefore, the aspect shown in the lower row of FIG. 2 is only an example of the concavo-convex pattern 81. In the lower row of FIG. 2, a reference numeral “82” is assigned to one of the plurality of concave portions 82, and a reference numeral “83” is assigned to one of the plurality of convex portions 83. The previously described longitudinal direction and transverse direction are orthogonal to each other. The transverse direction of the base material 85 can also be referred to as a transverse direction of the decorative sheet 80. The longitudinal direction of the base material 85 can also be referred to as the longitudinal direction of the decorative sheet 80.

The decorative sheet 80 does not include the following concave shaped portion on a back face of the base material 85 (see the lower row of FIG. 2). The concave shaped portion previously described is a concave shaped portion corresponding to the concave portion 82 of the concavo-convex pattern 81 on the front face. That is, the back face of the base material 85 is maintained in the same state before and after embossing by the embossing apparatus 10 (see FIG. 2). As the base material 85, various sheet materials are employed. Therefore, the base material 85 includes, for example, various sheet materials from which thickness differ. The base material 85 has cushioning properties. In the embodiment, the base material 85 is a three-layer laminate body (see the upper row of FIG. 2). In this case, the base material 85 includes a first sheet 86, a second sheet 87 and a third sheet 88. However, the base material may be a laminated body of two layers or four or more layers. For example, when the base material is a two-layer laminated body, the base material may be a laminated body composed of the first sheet 86 and the second sheet 87.

In the embodiment, one side in a laminating direction is referred to as “front side”, and the other side in the laminating direction is referred to as “back side”. The laminating direction is a direction in which the first sheet 86, the second sheet 87 and the third sheet 88 are laminated in the base material 85. The laminating direction coincides with a thickness direction of the base material 85. In the base material 85, the front side in the laminating direction is a side on which the first sheet 86 is provided, and the back side in the laminating direction is a side on which the third sheet 88 is provided. In each sheet material of the base material 85, the first sheet 86, the second sheet 87 and the third sheet 88, the front face is a surface that is on the front side in the laminating direction, and the back face is a surface that is on the back side in the laminating direction. By embossing, the front face of the base material 85 becomes a front face of the decorative sheet 80, and the back face of the base material 85 becomes a back face of the decorative sheet 80. For example, when the decorative sheet 80 is a front face fabric of an interior product for a vehicle, the front face of the decorative sheet 80 is a surface of the previously described interior product. The user of the vehicle visually recognizes the front face of the decorative sheet 80 that forms the surface of the interior product.

A thickness of the base material 85 is better to be set to a predetermined value in the range of 0.7 to 23 mm. Preferably, the lower limit of the thickness of the base material 85 is 2 mm or more. However, the thickness of the base material 85 may be a value different from the previously described range. The thickness of the base material 85 is appropriately determined in consideration of various conditions. For example, the thickness of the base material 85 is determined in consideration of workability in embossing. The base material 85 is formed as follows. That is, the first sheet 86 is bonded to the front face of the second sheet 87. The third sheet 88 is bonded to the back face of the second sheet 87. A known technique is employed for bonding the second sheet 87 and the first sheet 86 and bonding the second sheet 87 and the third sheet 88. For example, each bonding previously described is performed via an adhesive. In addition, each of the previously described bonding is performed by frame laminate. When comparing the previously described two techniques, the inventor considers that frame laminate is preferred. Frame laminate is advantageous in terms of process load at the time of manufacturing the base material 85 and weight reduction of the base material 85. Frame laminate is a technology that has already been put to practical use. Therefore, the description regarding the frame laminate is omitted. With respect to the first sheet 86, the second sheet 87 and the third sheet 88, they will be described later.

The embossing apparatus 10 includes an embossing die 20, an embossing receiving die 30 and a heating unit 40 (see FIG. 1). The embossing die 20 has a roll shape. In this case, the embossing die 20 may be referred to as an embossing roll. The embossing receiving die 30 has a roll shape. In this case, the embossing receiving die 30 may be referred to as a receiving roll or a backup roll. The embossing die 20 and the embossing receiving die 30 are provided side by side in an arrangement direction. The embossing die 20 is provided on a first side in the arrangement direction. The embossing receiving die 30 is provided on a second side in the arrangement direction. In the embodiment, the arrangement direction is a vertical direction, and the conveying direction is a horizontal direction. The first side in the arrangement direction is an upper side in the vertical direction, and the second side in the arrangement direction is a lower side in the vertical direction. In this case, the laminating direction of the base material 85 coincides with the vertical direction. However, the arrangement direction may be a direction different from the vertical direction. The conveying direction may be a direction different from the horizontal direction. The conveying direction is better to be a direction orthogonal to the arrangement direction.

The embossing die 20 includes a concavo-convex shaped molding unit 22. When the embossing die 20 has a roll shape, the embossing die 20 includes a shaft 28. The embossing die 20 may be formed of a material having a hardness higher than that of an elastic unit 32 described later. For example, the embossing die 20 is better to be made of metal. An example of the metal forming the embossing die 20 includes steel. However, the embossing die 20 may be formed of a material different from metal. For example, the embossing die 20 may be made of ceramic or resin. An example of the resin forming the embossing die 20 includes silicone rubber.

The molding unit 22 is in contact with the front face of the base material 85 and presses the front face of the base material 85. The molding unit 22 includes a convex portion 24 and a concave portion 26. The convex portion 24 is a portion of the molding unit 22 which corresponds to the concave portion 82 of the concavo-convex pattern 81. The concave portion 26 is a portion of the molding unit 22 which corresponds to the convex portion 83 of the concavo-convex pattern 81. It is assumed that the concavo-convex pattern 81 is a pattern formed by a plurality of concave portions 82 and a plurality of convex portions 83 (see the lower row of FIG. 2). In this case, the molding unit 22 includes a plurality of convex portions 24 and a plurality of concave portions 26 (see FIG. 1). The shape of the convex portion 24, the shape of the concave portion 26, and the arrangement of the convex portion 24 and the concave portion 26 are appropriately determined in consideration of the aspect of the concavo-convex pattern 81. Examples of the shape of the convex portion 24 include, as in the case of the concave portion 82 of the concavo-convex pattern 81 mentioned above, a cone shape, a frustum shape, a columnar shape and a hemispherical shape. In FIG. 1, a reference numeral “24” is assigned to one of the plurality of convex portions 24, and a reference numeral “26” is assigned to one of the plurality of concave portions 26. In the molding unit 22, a height difference ΔH is a first value. The height difference AH is a difference between the height of a top portion of the convex portion 24 and the height of a bottom portion of the concave portion 26 (see FIG. 1). The first value of the height difference ΔH is appropriately determined in consideration of the aspect of the concavo-convex pattern 81.

The embossing die 20 rotates in a direction corresponding to the conveying direction with the shaft 28 as a rotation axis. In FIG. 1, shaft center C1 indicates a shaft center of the shaft 28. The shaft center C1 coincides with a center line of the shaft 28 along a direction perpendicular to the paper surface of FIG. 1. The embossing die 20 is given a driving force from a drive unit. The drive unit is attached to the shaft 28. Along with this, the embossing die 20 rotates as previously described. In FIG. 1, illustration of the drive unit is omitted. An example of a drive unit includes a motor. The following arrow shown in FIG. 1 indicates a rotation direction of the embossing die 20. The previously described arrow is a single arrow shown inside the embossing die 20.

The embossing receiving die 30 includes an elastic unit 32 made of resin. The elastic unit 32 is provided on an outer surface of a main body unit 34. The elastic unit 32 is integrated with the main body unit 34 on the outer surface of the main body unit 34. In the elastic unit 32, the following surface is a smooth surface. The previously described surface is a surface of the elastic unit 32 that forms an outer surface of the embossing receiving die 30. “Smooth” means, for example, a state having no height difference or a state having no concavo-convex. Therefore, “smooth surface” includes, for example, a smooth plane and a smooth curved surface. When the embossing receiving die 30 has a roll shape, the previously described surface of the elastic unit 32 is a smooth curved surface. The main body unit 34 is formed of the same material as the embossing die 20. A shaft 36 is fixed to the main body unit 34. The embossing receiving die 30 rotates in a direction corresponding to the conveying direction with the shaft 36 as a rotation axis. A rotation direction of the embossing receiving die 30 is opposite to the rotation direction of the embossing die 20. In FIG. 1, shaft center C2 indicates a shaft center of the shaft 36. The shaft center C2 coincides with a center line of the shaft 36 along a direction perpendicular to the paper surface of FIG. 1. The elastic unit 32 is in contact with the back face of the base material 85. In the embossing apparatus 10, the embossing die 20 and the embossing receiving die 30 sandwich the base material 85 between the molding unit 22 and the elastic unit 32. The embossing receiving die 30 rotates following the rotation of the embossing die 20 with the elastic unit 32 in contact with the back face of the base material 85. The following arrow shown in FIG. 1 indicates the rotation direction of the embossing receiving die 30. The previously described arrow is a single arrow shown inside the embossing receiving die 30.

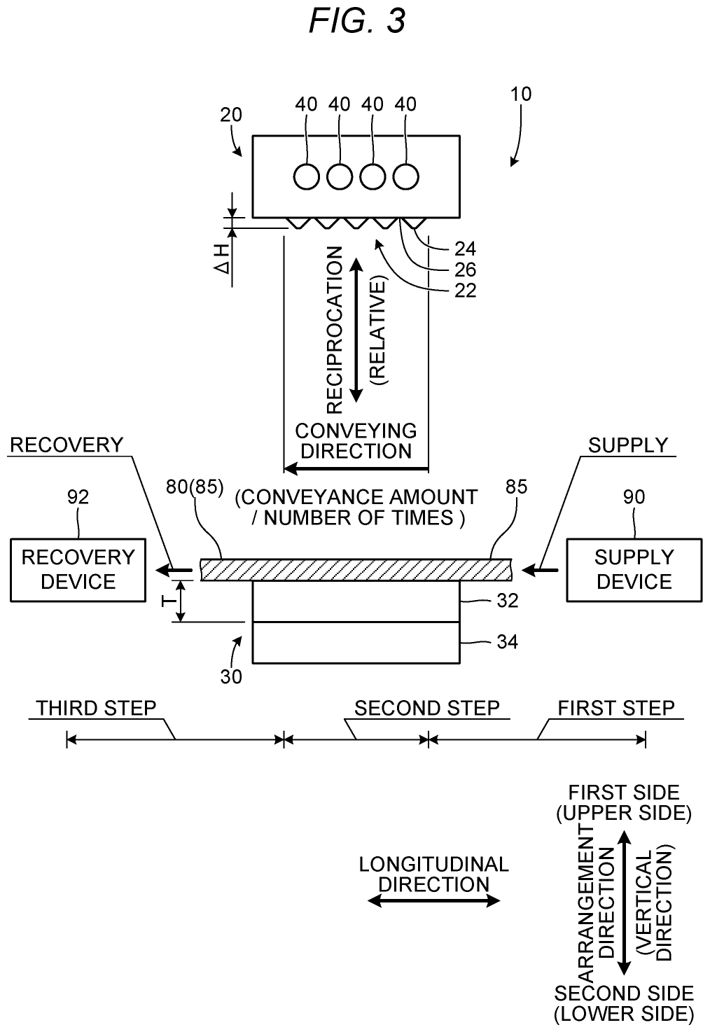

In the elastic unit 32, a thickness T is a second value. The thickness T is a thickness of the elastic unit 32 in a direction perpendicular to the outer surface of the embossing receiving die 30. When the embossing receiving die 30 has a roll shape, the direction perpendicular to the outer surface of the embossing receiving die 30 coincides with a radial direction of the embossing receiving die 30 having a roll shape. The thickness T is a thickness of the elastic unit 32 in the following state. The state previously described is a state in which no pressing force is applied to the elastic unit 32 and the elastic unit 32 is not deformed. In the embossing apparatus 10, the relationship between the first value of the height difference ΔH and the second value of the thickness T is set to “first value≤second value”. However, in FIG. 1 and FIG. 3 to be described later, the convex portion 24 and the concave portion 26 of the molding unit 22 and the elastic unit 32 are illustrated in a state of “first value<second value”.

The elastic unit 32 is formed of a known resin. However, the elastic unit 32 is better to be formed of a resin having a hardness of A90 or less. Preferably, the elastic unit 32 is formed of a resin having a hardness of A70 or less. More preferably, the elastic unit 32 is formed of a resin having a hardness of A60 or less. Each value previously described is an average value of hardness acquired by the following hardness test method. This hardness test method is carried out conforming to JIS K6253-3: 2012 (vulcanized rubber and thermoplastic rubber—how to determine hardness—part 3: durometer hardness).

### [Hardness Test Method]

Testing machine: Type A durometer (KOBUNSHI KEIKI CO., LTD. Digital rubber hardness tester DD4-A type)
Specimen shape (width×length×thickness): 40 mm×60 mm×11 mm
Test environment (temperature, relative humidity): 23±2° C., 50±5% RH
Measurement time: Moment
Number of measurement points: 5 points

By forming the elastic unit 32 with the resin having a hardness of A90 or less, the following effects can be obtained. That is, in the embossing apparatus 10, the elastic unit 32 is deformed when the base material 85 passes between the embossing die 20 and the embossing receiving die 30. In this case, the deformation of the elastic unit 32 is elastic deformation. Due to the deformation of the elastic unit 32, the area of the elastic unit 32 in contact with the back face of the base material 85 can be increased. Along with this, the following concavo-convex pattern 81 can be uniformly reproduced on the front face of the decorative sheet 80. The concavo-convex pattern 81 previously described is a concavo-convex pattern including the concave portion 82 that matches the convex portion 24 of the molding unit 22 and the convex portion 83 that matches the concave portion 26 of the molding unit 22. Shine of the concave portion 82 can be suppressed. It is possible to prevent the texture on the front face and the back face of the decorative sheet 80 from becoming hard. Discoloration of the front face and the back face of the decorative sheet 80 can be prevented. These points will be confirmed in the examples described later. In the embossing apparatus 10, for example, the following damage due to the pressing force from the embossing die 20 can be suppressed from occurring in the embossing receiving die 30. The damage previously described is that an indentation of the convex portion 24 of the molding unit 22 is formed in the following portion of the embossing receiving die 30. The portion previously described is the smooth surface of the elastic unit 32 that becomes the outer surface of the embossing receiving die 30. In FIG. 1, the illustration of the elastic unit 32 is simplified. In FIG. 1, the elastic unit 32 is not shown in the state where the deformation previously described has occurred.

As the resin which forms the elastic unit 32, the following resin whose hardness is A90 or less is employed. Examples of the resin previously described include rubbers, thermoplastics elastomers and plastics. The inventor considers that rubber is preferable among the resins previously described. Examples of the rubbers include silicone rubber, nitrile rubber, chloroprene rubber, ethylene-propylene rubber, butyl rubber, urethane rubber, fluoro-rubber and natural rubber. The inventor considers that silicone rubber or fluoro-rubber is preferable in terms of heat resistance. The inventor considers nitrile rubber, urethane rubber or natural rubber is preferable in terms of durability. The inventor considers that silicone rubber is preferable among the rubbers previously described in terms of versatility. Silicone rubber has excellent heat resistance as previously described. Silicone rubber is inexpensive. The rubber forming the elastic portion 32 may be one or two or more kinds of rubbers selected from the group including the plurality of rubbers previously described. In addition, the rubber forming the elastic unit 32 may be pure rubber. However, this rubber may contain one or more known additives. Examples of the additives previously described include fillers, plasticizers, vulcanizing agents and antioxidants.

The elastic unit 32 is better to be formed of a resin having a compression set of 10% or less. Preferably, the elastic unit 32 is formed of a resin having a compression set of 5% or less. More preferably, the elastic unit 32 is formed of a resin having a compression set of 3% or less. Each of the values previously described is an average value of compression set obtained by the following compression set test method. This compression set test method is carried out conforming to JIS K6262: 2013 (vulcanized rubber and thermoplastic rubber—how to determine compression set at normal temperature, high temperature and low temperature).

### [Compression Set Test Method]

Testing machine: Constant pressure thickness measuring instrument (TECLOCK CO., LTD. PG-20 type J)
Specimen shape (diameter×thickness): φ29 mm×11 mm
Number of specimens: 3
Test time: 22 hours
Test temperature: 23° C.
Compression rate: 25%
Test environment (temperature, relative humidity): 23±2° C., 50±5% RH

By forming the elastic unit 32 with the resin having a compression set of 10% or less, the following effects can be obtained. That is, even when the embossing is performed for a long time, distortion generated in the embossing receiving die 30 can be suppressed. The following concavo-convex pattern 81 can be uniformly reproduced on the front face of the decorative sheet 80. The concavo-convex pattern 81 previously described is a concavo-convex pattern including the concave portion 82 that matches the convex portion 24 of the molding unit 22 and the convex portion 83 that matches the concave portion 26 of the molding unit 22. This point will be confirmed in the examples described later.

The elastic unit 32 is better to be formed of a resin having a compression stress relaxation of 30% or less at 80° C. Preferably, the elastic unit 32 may be formed of a resin having a compression stress relaxation of 25% or less at 80° C. Each of the values previously described is an average value of compressive stress relaxation obtained by the following compressive stress relaxation test method. This compressive stress relaxation test method is carried out conforming to the compressive stress relaxation test method A of JIS K6263: 2015 (vulcanized rubber and thermoplastic rubber—how to determine stress relaxation).

### [Compressive Stress Relaxation Test Method]

Testing machine: Compression load cell for high temperature (KYOWA ELECTRONIC INSTRUMENTS CO., LTD. LC-100KFH)
   Data logger (TOKYO MEASURING INSTRUMENTS LABORATORY CO., LTD. TDS-530)
   Programmable low temperature and temperature and humidity chamber (TOYO SEIKI SEISAKU-SHO, LTD. AGX2)
Specimen shape (diameter×thickness): φ29 mm×11 mm
Number of specimens: 3
Test time: 168 hours
Test temperature: 80±2° C.
Lubricant: Silicone grease (G-30M manufactured by SHIN-ETSU CHEMICAL CO., LTD.)

By forming the elastic unit 32 with the risen having a compression stress relaxation of 30% or less at 80° C., the following effects can be obtained. That is, even when the embossing is performed for a long time, distortion generated in the embossing receiving die 30 can be suppressed. The following concavo-convex pattern 81 can be uniformly reproduced on the front face of the decorative sheet 80. The concavo-convex pattern 81 previously described is a concavo-convex pattern including the concave portion 82 that matches the convex portion 24 of the molding unit 22 and the convex portion 83 that matches the concave portion 26 of the molding unit 22. This point will be confirmed in the examples described later.

The elastic unit 32 is better to be formed of a resin having an impact resilience coefficient of 30% or more. Preferably, the elastic unit 32 is formed of a resin having an impact resilience coefficient of 50% or more. Each of the values previously described is an average value of the impact resilience coefficient obtained by the following impact resilience coefficient test method. This impact resilience coefficient test method is carried out conforming to JIS K6255: 2013 (vulcanized rubber and thermoplastic rubber—how to determine the impact resilience coefficient).

### [Impact Resilience Coefficient Test Method]

Testing machine: Lupke-type impact resilience tester (UESHIMA SEISAKUSHO CO., LTD. U00716)
Specimen shape (diameter×thickness): φ29 mm×11 mm
Number of specimens: 2
Test environment (temperature, relative humidity): 23±2° C., 50±10% RH

By forming the elastic unit 32 with the resin having an impact resilience coefficient of 30% or more, the following effects can be obtained. That is, in the embossing apparatus 10, the pressing force from the molding unit 22 applies on the elastic unit 32 in the following state. The state previously described is a state in which the embossing die 20 and the embossing receiving die 30 sandwich the base material 85 between the molding unit 22 and the elastic unit 32. In the elastic unit 32, the following area deforms locally. The area previously described is a predetermined area of the elastic unit 32 that faces the convex portion 24 of the molding unit 22. However, the pressing force previously described does not apply on the elastic unit 32 in a separation range R. The separation range R is a range in which the elastic portion 32 is separated from the back face of the base material 85 in the outer surface of the embossing receiving die 30 (see FIG. 1). The portion of the elastic unit 32 that has been deformed can be smoothly recovered within the separation range R, and then returned to the state before deformation until the next pressing force is applied. Along with this, when the base material 85 passes between the embossing die 20 and the embossing receiving die 30, the pressing force can be appropriately applied to the base material 85. A sufficient concavo-convex pattern 81 can be shaped (formed) on the front face of the base material 85. This point will be confirmed in the examples described later. In FIG. 1, the elastic unit 32 is not illustrated in a state in which the local deformation previously described has occurred.

The heating unit 40 is provided in the embossing die 20. The heating unit 40 is embedded in the embossing die 20. The heating unit 40 is an electric heater. In the embodiment, four heating units 40 using electric heaters are embedded in the embossing die 20 at equal angular intervals. However, the heating unit 40 may be a model of heating unit different from the electric heater. The number of heating units 40 may be 3 or less or 5 or more. The model and number of the heating units 40 are appropriately determined in consideration of various conditions. The arrangement of the heating units 40 in the embossing die 20 is appropriately determined in consideration of various conditions.

The heating unit 40 heats the embossing die 20 to a predetermined temperature. The temperature previously described is appropriately set according to the type of the base material 85. For example, the temperature previously described is appropriately set in consideration of a material of either one or both of the first sheet 86 and the second sheet 87. It is assumed that the first sheet 86 is polyethylene terephthalate. The melting point of polyethylene terephthalate is 260° C. In this case, the heating unit 40 heats the embossing die 20 to a predetermined value in the range of 60 to 260° C. Preferably, the heating unit 40 heats the embossing die 20 to a predetermined value in the range of 60 to 220° C. More preferably, the heating unit 40 heats the embossing die 20 to a predetermined value in the range of 130 to 210° C.

By setting the heating temperature of the embossing die 20 to 60° C. or higher, a sufficient concavo-convex pattern 81 can be shaped on the front face of the base material 85. By setting the heating temperature of the embossing die 20 to 260° C. or less, the following defects can be prevented from occurring in the concave portion 82 of the concavo-convex pattern 81. The defects previously described are shine, discoloration and tearing. This is the same to the back face of the decorative sheet 80 that becomes a smooth surface. Furthermore, it is possible to prevent the texture of the front face and the back face of the decorative sheet 80 from becoming hard. These points will be confirmed in the examples described later. In addition, while the embossing die 20 is heated by the heating unit 40, the embossing receiving die 30 can be prevented from being deformed by not directly heating the embossing receiving die 30.

### <Embossing Method>

The embossing method will be described with reference to FIG. 1 and FIG. 2. The embossing method is performed by the embossing apparatus 10. The embossing method includes a first step, a second step and a third step (see FIG. 1). By the embossing method, the decorative sheet 80 shown in the lower row of FIG. 2 is manufactured from the base material 85 shown in the upper row of FIG. 2. Therefore, the embossing method can be said to be a method for manufacturing the decorative sheet 80. In the embossing method, the first step, the second step and the third step are sequentially and continuously performed while the base material 85 is continuously conveyed in the conveying direction. The first step is continuously performed with respect to the base material 85 conveyed continuously. The second step is continuously performed with respect to the base material 85 conveyed continuously. The third step is continuously performed with respect to the base material 85 conveyed continuously. In the embossing apparatus 10, when the embossing method is performed, the drive unit for the embossing die 20 is continuously driven.

In the embossing method, by pressing the base material 85, the concave portion 82 and the convex portion 83 having predetermined dimensions in the laminating direction are shaped on the front face of the base material 85 (see FIG. 2). The heating unit 40 heats the embossing die 20. That is, the embossing method is performed in a state in which the embossing die 20 is heated to the predetermined temperature mentioned above. In the embossing apparatus 10, a heating unit such as the heating unit 40 for the embossing die 20 is not provided in the embossing receiving die 30. Therefore, in the embossing method, the embossing receiving die 30 is not directly heated.

The first step is a step of supplying the base material 85 to the embossing apparatus 10 (see FIG. 1). That is, in the first step, the base material 85 is fed out from the supply device 90. The base material 85 fed out from the supply device 90 is conveyed in the conveying direction and reaches the embossing apparatus 10.

The second step is a step of embossing the base material 85 that has reached the embossing apparatus 10 (see FIG. 1). That is, the base material 85 conveyed in the conveying direction passes between the embossing die 20 and the embossing receiving die 30 during conveyance. At this time, the base material 85 is in contact with the outer surface of the elastic unit 32 on the back face and is supported by the elastic unit 32 from the back side. The base material 85 is in contact with the molding unit 22 on the front face and is pressed by the molding unit 22. The convex portion 24 of the molding unit 22 bites into the base material 85. The base material 85 is heated by the heat from the embossing die 20 heated by the heating unit 40. By the second step, the concavo-convex pattern 81 is shaped on the front face of the base material 85. Along with this, the base material 85 is formed into the decorative sheet 80 (see FIG. 2). In the aspect shown in FIG. 1, the base material 85 is in contact with the bottom portion of the concave portion 26 of the molding unit 22 when the second step is performed. However, such aspect is an example. When the second step is performed, the base material 85 may not contact the bottom portion of the concave portion 26 of the molding unit 22.

The third step is a step of recovering the base material 85 which passed the embossing apparatus 10 (see FIG. 1). That is, in the third step, the decorative sheet 80 is recovered from the embossing apparatus 10 by the recovery device 92.

In the embossing method, a conveyance speed of the base material 85 is better to be set to a predetermined value in the range of 0.1 to 10 m/min. Preferably, the conveyance speed of the base material 85 is set to a predetermined value in the range of 0.3 to 5 m/min. By setting the conveyance speed of the base material 85 to 0.1 m/min or more, the following defects can be prevented from occurring in the concave portion 82 of the concavo-convex pattern 81. The defects previously described are shine, discoloration and tearing. This is the same to the back face of the decorative sheet 80 that is a smooth surface. Furthermore, it is possible to prevent the texture of the front face and the back face of the decorative sheet 80 from becoming hard. Further, by setting the conveyance speed of the base material 85 to 0.1 m/min or more, it can suppress the embossing receiving die 30 deform by the heat from the embossing die 20. By setting the conveyance speed of the base material 85 to 10 m/min or less, when the base material 85 passes between the embossing die 20 and the embossing receiving die 30, the pressing force can be appropriately applied to the base material 85. A sufficient concavo-convex pattern 81 can be shaped on the front face of the base material 85.

In the second step, a pressing time of the base material 85 is better to be set to a predetermined value in the range of 0.01 to 5 seconds. Preferably, the pressing time of the material 85 is set to a predetermined value in the range of 0.1 to 2 seconds. The pressing time of the base material 85 is appropriately set in consideration of the shape of the molding unit 22 (the convex portion 24 and the concave portion 26). By setting the pressing time of the base material 85 to 0.01 seconds or more, when the base material 85 passes between the embossing die 20 and the embossing receiving die 30, the pressing force can be appropriately applied to the base material 85. A sufficient concavo-convex pattern 81 can be shaped on the front face of the base material 85. By setting the pressing time of the base material 85 to 5 seconds or less, the following defects can be prevented from occurring in the concave portion 82 of the concavo-convex pattern 81. The defects previously described are shine, discoloration and tearing. This is the same to the back face of the decorative sheet 80 that is a smooth surface. Furthermore, it is possible to prevent the texture of the front face and back face of the decorative sheet 80 from becoming hard. Further, by setting the pressing time of the base material 85 to 5 seconds or less, it can suppress the embossing receiving die 30 deform by the heat from the embossing die 20.

In the second step, the pressing force of the base material 85 is better to be set to a predetermined value in the range of 200 to 2000 N/cm. By setting the pressing force of the base material 85 to 200 N/cm or more, when the base material 85 passes between the embossing die 20 and the embossing receiving die 30, the pressing force can be appropriately applied to the base material 85. A sufficient concavo-convex pattern 81 can be shaped on the front face of the base material 85. By setting the pressing force of the base material 85 to 2000 N/cm or less, the following defects can be prevented from occurring in the concave portion 82 of the concavo-convex pattern 81. The defects previously described are shine, discoloration, and tearing. This is the same to the back face of the decorative sheet 80 that is a smooth surface. Furthermore, it is possible to prevent the texture of the front face and the back face of the decorative sheet 80 from becoming hard. Further, by setting the pressing force of the base material 85 to 2000 N/cm or less, it can suppress the embossing receiving die 30 deform by the heat from the embossing die 20.

### <First Sheet, Second Sheet, Third Sheet>

As the first sheet 86, various sheet materials are employed. For example, as the first sheet 86, a fibrous sheet material is employed. Examples of the fibrous sheet material include woven fabrics, knitted fabrics, non-woven fabrics and natural leathers. Natural leather includes split. In addition, as the first sheet 86, the following sheet material is employed. The sheet material previously described is a sheet material in which a synthetic resin is impregnated or laminated on the fibrous sheet material. Examples of such a sheet material include synthetic leathers, artificial leathers and vinyl chloride leathers. A thickness of the first sheet 86 is better to be set to a predetermined value in the range of 0.2 to 8 mm. Preferably, the thickness of the first sheet 86 is set to be a predetermined value in the range of 0.3 to 5 mm. However, the thickness of the first sheet 86 may be a value different from the range previously described. The thickness of the first sheet 86 is appropriately determined in consideration of various conditions.

In the first sheet 86, the fibrous sheet material is better to be a sheet material made of thermoplastic resin fibers in terms of workability in embossing. Examples of the thermoplastic resin include polyolefin resins, polyester resins, polyamide resins, polyvinyl chloride and polyvinylidene chloride. Examples of the polyolefin resins include polyethylene and polypropylene. An example of the polyester resins include polyethylene terephthalate. Examples of the polyamide resins include nylon 6 and nylon 66. The fibrous sheet material can be formed using, as a raw material, one or two or more types of thermoplastic resin fibers selected from the group including a plurality of resins previously described.

It is assumed that the first sheet 86 is a sheet material in which a synthetic resin is impregnated or laminated on the fibrous sheet material. In this case, a known synthetic resin is employed as the resin to be impregnated or laminated. Examples of the synthetic resins previously described include polyurethane resin and vinyl chloride resin. Furthermore, the fibrous sheet material may be colored with a known dye or pigment. The dye or pigment is appropriately determined in consideration of various conditions.

The second sheet 87 has cushioning properties. Therefore, the base material 85 has cushioning properties as mentioned above. As the second sheet 87, various sheet materials having cushioning properties are employed. Examples of such sheet materials include woven fabrics, knitted fabrics, nonwoven fabrics and synthetic resin foams. The inventor considers that synthetic resin foams are preferable among the sheet materials previously described having cushioning properties in terms of processability in embossing. Examples of the synthetic resin foams include polyurethane foam, polystyrene foam, polyethylene foam, polypropylene foam, phenol foam, silicone foam, acrylic foam and polyimide foam. The inventor considers that polyurethane foam is preferable among the synthetic resin foams previously described in terms of versatility.

A thickness of the second sheet 87 is better to be set to a predetermined value in the range of 0.5 to 15 mm. Preferably, the thickness of the second sheet 87 is set to a predetermined value in the range of 1 to 10 mm. However, the thickness of the second sheet 87 may be a value different from the range previously described. The thickness of the second sheet 87 is appropriately determined in consideration of various conditions. A density of the second sheet 87 is better to be set to a predetermined value in the range of 16 to 60 kg/m³. Preferably, the density of the second sheet 87 is set to a predetermined value in the range of 20 to 40 kg/m³. The density previously described is an apparent density obtained conforming to JIS K7222: 2005 (foamed plastics and rubbers—how to determine the apparent density). However, the density of the second sheet 87 may be a value different from the range previously described. The density of the second sheet 87 is appropriately determined in consideration of various conditions. A hardness of the second sheet 87 is better to be a predetermined value in the range of 36 to 360N. The hardness previously described is a hardness obtained conforming to the hardness test D method of JIS K6400-2: 2012 (flexible foam material—physical characteristics—part 2: hardness and compressive stress—how to determine the strain characteristics). However, the hardness of the second sheet 87 may be a value different from the range previously described. The hardness of the second sheet 87 is appropriately determined in consideration of various conditions.

As the third sheet 88, various sheet materials are employed. For example, as the third sheet 88, a fabric is employed. An example of the fabric include a fabric made of a synthetic fiber. Examples of synthetic fibers include nylon and polyester. When the base material 85 includes the third sheet 88, the third sheet 88 can prevent the second sheet 87 from being damaged on the back face side of the base material 85. Furthermore, the third sheet 88 can suppress contamination of a predetermined portion of the embossing apparatus 10 that is in contact with the back face of the base material 85 when the embossing method is performed. In addition, for example, when the decorative sheet 80 is sewn, the third sheet 88 enables the decorative sheet 80 to smoothly slide with respect to the following contact object. The contact object previously described is, for example, a sewing machine presser. The decorative sheet 80 is often sewn in a state in which the front faces of the two decorative sheets 80 are in contact with each other. In this case, the decorative sheet 80 is in contact with the presser previously described on the back face. The decorative sheet 80 is sewn in a state of being pressed by the presser. When a binding is provided, the two decorative sheets 80 are in a state in which the respective back surfaces are in contact with each other. In this case, the back surface of the decorative sheet 80 serving as the counterpart is the contact object previously described. A thickness of the third sheet 88 is better to be set to a predetermined value in which the thickness of the base material 85 is within the range mentioned above in consideration of the thicknesses of the first sheet 86 and the second sheet 87.

### EXAMPLES

The inventor conducted an experiment to confirm the effectiveness of the embossing apparatus 10 of the embodiment. Hereinafter, experimental results obtained by this experiment will be described. At this time, in order to clarify the correspondence with the description above, the reference numerals for the respective parts are the same as those described above.

(1) Experimental Method

In the experiment, a sample corresponding to the decorative sheet 80 was evaluated. The embossing apparatus 10 was used to manufacture the sample. Both the embossing die 20 and the embossing receiving die 30 have a roll shape (see FIG. 1). The base material 85 was made into a laminated body of three layers (see upper row of FIG. 2). The first sheet 86, the second sheet 87 and the third sheet 88 were bonded together by frame laminate. The specifications of the embossing apparatus 10, the processing conditions of the embossing method and the specifications of the base material 85 are as follows. In the embossing die 20, a radial direction coincides with a radiation direction centered on the shaft center C1 of the shaft 28, a width direction coincides with a direction of the shaft center C1 and a circumferential direction coincides with the rotation direction of the embossing die 20 and the opposite direction thereof (see FIG. 1). In the embossing receiving die 30, the radial direction coincides with a radiation direction centered on the shaft center C2 of the shaft 36, the width direction coincides with a direction of the shaft center C2 and the circumferential direction coincides with the rotation direction of the embossing receiving die 30 and the opposite direction thereof (see FIG. 1). The width direction (direction of the shaft centers C1 and C2) is a direction perpendicular to the paper surface of FIG. 1 and coincides with the transverse direction of the base material 85. A dimension L1 shown in FIG. 1 shows a dimension in the radial direction of the embossing die 20. A dimension L2 shown in FIG. 1 shows a dimension in the radial direction of the embossing receiving die 30.

### [Specifications of Embossing Apparatus 10]

Dimensions of embossing die 20: 203 mm×750 mm (radial direction×width direction (excluding shaft 28))
Configurations of molding unit 22

Arrangement of convex portions 24: arranged at intervals of 1 mm in circumferential direction and width direction

Shape of convex portion 24: square frustum shape

Dimension of the convex portion 24 (bottom dimension, height): 10 mm×10 mm (circumferential direction×width direction), 2.79 mm
Dimension of embossing receiving die 30: 300 mm×750 mm (radial direction x width direction (excluding shaft 36))
Configurations of elastic unit 32

Shape of outer surface: smooth surface (smooth curved surface)

Material: Silicone rubber

Thickness T: 20 mm

Hardness: A57

Compression set: 2.9%

Compression stress relaxation (80° C.): 16%

Impact resilience coefficient: 56%

### [Processing Conditions of Embossing Method]

Embossing die 20 surface temperature: 170° C.

Heating of embossing receiving die 30: None

Conveyance speed: 0.5 m/min

Pressing force: 328 N/cm

### [Specifications of Base Material 85]

Thickness of base material 85: 5.8 mm

First sheet 86 (material, thickness, basis weight): dobby woven fabric, 0.75 mm, 390 g/m²

Second sheet 87 (material, thickness, density (apparent density), hardness): flexible urethane foam sheet, 5 mm, 20 kg/m³, 98.1 N

Third sheet 88 (material, basis weight): nylon half tricot knitted fabric, 14.4 g/m²

### (2) Evaluation

In this experiment, with respect to the reproducibility of the concavo-convex pattern 81, the shine of the concave portion 82 of the concavo-convex pattern 81, the texture of the front face and back face of the decorative sheet 80 and the discoloration of the front face and back face of the decorative sheet 80, sensory evaluation was performed according to the following evaluation criteria. As a result, in the sample to be evaluated, the rating was “A” in all items. The back surface of the sample was in the same state as the back face of the base material 85 before embossing. That is, a concave shaped portion corresponding to the concave portion 82 of the concavo-convex pattern 81 was not recognized on the back surface of the sample.

### [Reproducibility of Concavo-Convex Pattern 81]

A: Reverse pattern of molding unit 22 is faithfully reproduced.

B: Reverse pattern of molding unit 22 is almost reproduced.

C: Reverse pattern of molding unit 22 is not reproduced.

### [Shine of Concave Portion 82 of Concavo-Convex Pattern 81]

A: No shine is seen in concave 82

B: Some shine is seen in concave 82

C: Shine is seen in concave 82

### [Texture of Front Face and Back Face of Decorative Sheet 80]

A: Soft texture

B: Slightly hard texture

C: Hard texture

### [Discoloration of Front Face and Back Face of Decorative Sheet 80]

A: Discoloration is not seen

B: Slight discoloration is seen

C: Discoloration is seen

### Effect of Embodiment

According to the embodiment, the following effects can be obtained.

(1) The embossing apparatus 10 includes the embossing die 20 and the embossing receiving die 30 (see FIG. 1). The embossing die 20 includes the concavo-convex shaped molding unit 22. The molding unit 22 is in contact with the front face of the base material 85. The embossing receiving die 30 includes the elastic unit 32 made of resin. The elastic unit 32 is in contact with the back face of the base material 85. In the molding unit 22, the height difference AH is the first value. In the elastic unit 32, the surface which forms the outer surface of the embossing receiving die 30 is a smooth surface. In the elastic unit 32, the thickness T is the second value equal to or greater than the first value. The embossing die 20 and the embossing receiving die 30 sandwich the base material 85 between the molding unit 22 and the elastic unit 32.

Therefore, the three-dimensional concavo-convex pattern 81 can be shaped on the front face of the base material 85. In the decorative sheet 80, the following concave shaped portion can be suppressed to be formed on the back face of the base material 85. The concave shaped portion previously described is a concave shaped portion corresponding to the concave portion 82 of the concavo-convex pattern 81 on the front face. That is, according to the embossing apparatus 10, the following decorative sheet 80 can be manufactured. The decorative sheet 80 previously described has the three-dimensional concavo-convex pattern 81 on the front face, and has the back face that is maintained in the same state as before embossing. By making the back face of the decorative sheet 80 a smooth surface, a good texture and a good feel can be realized. Regardless of the shape of the convex portion 24 of the molding unit 22, the following defects can be prevented from occurring in the decorative sheet 80 with the embossing method. The defects previously described are shine, discoloration and tearing. Further, the defects previously described include that the texture becomes hard. Even if the convex portion 24 of the molding unit 22 has a shape that locally presses the base material 85, the defects previously described can be prevented. According to the embossing apparatus 10, it is possible to correspond to various concavo-convex patterns 81.

(2) The embossing apparatus 10 includes the heating unit 40 (see FIG. 1). The heating unit 40 heats the embossing die 20. In the embossing apparatus 10, a heating unit such as the heating unit 40 for the embossing die 20 is not provided in the embossing receiving die 30. Therefore, the embossing receiving die 30 is not directly heated during the embossing method. Therefore, the elastic unit 32 can be maintained at a desired hardness. Embossing can be performed on the base material 85 in a state in which the elastic unit 32 has a hardness suitable for embossing.

### <Modification>

The embodiment can also be performed as follows. Some configurations of the modifications shown below can be appropriately combined and employed. Hereinafter, points different from the above description will be described, and description of similar points will be appropriately omitted.

(1) In the embossing apparatus 10, the embossing die 20 and the embossing receiving die 30 have a roll shape and are supported so as to be rotatable in a direction corresponding to the conveying direction (see FIG. 1). The embossing die and the embossing receiving die may have a shape different from the roll shape. For example, the embossing die 20 and the embossing receiving die 30 may have a flat plate shape as shown in FIG. 3. In FIG. 3, in order to clarify the correspondence with FIG. 1, the reference numerals for the respective portions are the same as those described above.

In the embossing method performed by the embossing apparatus 10 shown in FIG. 3, the embossing die 20 reciprocates relative to the embossing receiving die 30. In this relative reciprocation movement, a movement from the first side to the second side in the arrangement direction and a movement from the second side to the first side in the arrangement direction are repeated. The base material 85 is intermittently conveyed in the conveying direction in a state in which the embossing die 20 is moved to the first side in the arrangement direction with respect to the embossing receiving die 30. A single conveyance amount is an amount corresponding to the dimension of the molding unit 22 with respect to the conveying direction. The embossing die 20 is provided with the heating unit 40. During the embossing method, the heating unit 40 heats the embossing die 20. A heating unit such as the heating unit 40 for the embossing die 20 is not provided in the embossing receiving die 30. In the embossing receiving die 30, the surface of the elastic unit 32 that forms the outer surface of the embossing receiving die 30 is a smooth flat surface. The elastic unit 32 is provided on the outer surface of the main body unit 34. In a state in which the embossing die 20 is moved to the second side in the arrangement direction, the base material 85 is sandwiched between the molding unit 22 and the elastic unit 32. Along with this, the concavo-convex pattern 81 is shaped on the front face of the base material 85 in the same manner as described above.

The relative movement of the embossing die 20 and the embossing receiving die 30 is better to be performed by reciprocating the embossing die 20 in the arrangement direction in a manner in which the position of the embossing receiving die 30 is fixed (see FIG. 3). However, the relative movement of the embossing die 20 and the embossing receiving die 30 may be a different aspect from this. For example, the relative movement of the embossing die 20 and the embossing receiving die 30 may be performed by reciprocating both the embossing die 20 and the embossing receiving die 30 in the arrangement direction. In the embossing apparatus, the embossing die and the embossing receiving die may be, for example, as follows. That is, the embossing apparatus may include the roll shaped embossing die 20 shown in FIG. 1 and the flat plate shaped embossing receiving die 30 shown in FIG. 3.

(2) In the embossing receiving die 30, the elastic unit 32 is provided on the outer surface of the main body unit 34 (see FIG. 1). In the embossing receiving die, the main body unit 34 may be omitted. In this case, the embossing receiving die has a structure in which the shaft is fixed to the elastic unit. In the embossing receiving die, the shaft may be also formed of the same material as the elastic unit.

(3) As a processing target of the embossing method by the embossing apparatus 10, the base material 85 that is a three-layer laminated body is illustrated as an example (see the upper row of FIG. 2). Furthermore, it has been explained that a two-layer laminated body or a laminated body of four or more layers can be employed as the base material. The base material may be a single-layer sheet material that is not a laminated body. That is, the base material may be a thick sheet material having cushioning properties. An example of such base material includes a double raschel knitted fabric. The inventor studied an embossing method for processing the following double raschel knitted fabric. The double raschel knitted fabric previously described is a double raschel knitted fabric which is not impregnated with a synthetic resin and is not laminated with a synthetic resin. In this study, the embossing method was performed by the embossing apparatus 10. As a result, the inventor confirmed that the same processability as described above was realized even when the base material was the double raschel knitted fabric previously described.

### DESCRIPTION OF REFERENCE NUMERALS

10 Embossing apparatus
20 Embossing die
22 Molding unit
24 Convex portion
26 Concave portion
28 Shaft
30 Embossing receiving die
32 Elastic unit
34 Main body unit
36 Shaft
40 Heating unit
80 Decorative sheet
81 Concavo-convex pattern
82 Concave portion
83 Convex portion
85 Base material
86 First sheet
87 Second sheet
88 Third sheet
90 Supply device
92 Recovery device
C2 Shaft center
L1, L2 Dimension
R Separation range
T Thickness
ΔH Height difference

1. An embossing apparatus comprising:
an embossing die which includes a concavo-convex shaped molding unit which is in contact with a front face of a base material; and
an embossing receiving die including a resin elastic unit which is in contact with a back face of the base material, wherein
in the molding unit, a height difference between a top portion of a convex portion and a bottom portion of a concave portion is a first value, and
in the elastic unit,
a surface which forms an outer surface of the embossing receiving die is a smooth surface, and
a thickness in a direction perpendicular to the outer surface of the embossing receiving die is a second value which is equal to or greater than the first value,
wherein the embossing die and the embossing receiving die sandwich the base material between the molding unit and the elastic unit.

2. The embossing apparatus according to claim 1, further comprising:
a heating unit which generates heat, wherein
the heating unit is,
provided in the embossing die and heats the embossing die, and
not provided in the embossing receiving die.
